(19) United States
(12) Patent Application Publication
(10) Pub. No.: US 2016/0065807 A1
(43) Pub. Date: Mar. 3, 2016

(54) PANORAMIC IMAGING SYSTEMS USING EXTERNAL ROTATING DEVICES

(71) Applicant: L-3 Communications Cincinnati Electronics Corporation, Mason, OH (US)

(72) Inventor: Stephen McClanahan, Mason, OH (US)

(73) Assignee: L-3 Communications Cincinnati Electronics Corporation, Mason, OH (US)

(21) Appl. No.: 14/844,405

(22) Filed: Sep. 3, 2015

Related U.S. Application Data
(60) Provisional application No. 62/045,269, filed on Sep. 3, 2014.

(51) Int. Cl. H04N 5/225; G06T 5/00; H04N 5/265; H04N 5/232

(52) U.S. Cl. CPC H04N 5/2253; H04N 5/23238; G06T 5/00; H04N 5/265; G06T 2207/20201

(57) ABSTRACT

Panoramic imaging systems and methods for manufacturing and arranging the same are disclosed. A panoramic imaging system includes a mounting frame, an image sensor coupled to the mounting frame, and an optical de-rotation device arranged in an optical path of the image sensor. The optical de-rotation device and the image sensor are oriented such that the optical de-rotation device and the image sensor are in the same plane. The optical de-rotation device removes motion-related blur that would be observed by the image sensor when a rotational movement external to the panoramic imaging system causes the panoramic imaging system to rotate.

### CROSS-REFERENCE TO RELATED APPLICATIONS

The present application claims priority to U.S. Provisional Patent Application Ser. No. 62/045,269, filed Sep. 3, 2014 and entitled “Surveillance Sensors for Continuous Rotational Imaging,” which is incorporated by reference herein in its entirety.

### TECHNICAL FIELD

The present specification generally relates to panoramic imaging systems and, more specifically, to panoramic imaging systems that are attachable to an external rotating device and includes an optical de-rotation mechanism.

### BACKGROUND

Panoramic imaging systems are used to provide a 360° viewing area to capture images, provide surveillance, and/or provide situational awareness, such as, for example in ground, nautical, and aerial surveillance systems. Some imaging sensors cannot capture the entire 360° field of view because they are not large enough. As a result, one solution for capturing a full 360° image includes using a single image sensor and rotating it about an axis so that the image sensor captures the entire 360° field of view as it rotates. However, devices that rotate the image sensor require rotational components that are complex, expensive, and prone to damage.

In addition, as the image sensor rotates, the image it obtains may be a blurred because the pixels of the image sensor may not be exposed to a particular field of view for long enough to generate a stable image.

Accordingly, a need exists for a system that leverages an existing rotating device that is external to the system for rotational movement. In addition, a need exists for a system that reduces rotational motion-induced blur observed by the image sensor.

### SUMMARY

In one embodiment, a panoramic imaging system includes a mounting frame, an image sensor coupled to the mounting frame, and an optical de-rotation device arranged in an optical path of the image sensor. The optical de-rotation device and the image sensor are oriented such that the optical de-rotation device and the image sensor are in the same plane. The optical de-rotation device removes motion-related blur that would be observed by the image sensor when a rotational movement external to the panoramic imaging system causes the panoramic imaging system to rotate.

In another embodiment, a method of arranging a panoramic imaging system may include providing the panoramic imaging system. The panoramic imaging system includes a mounting frame, an image sensor coupled to the mounting frame, and an optical de-rotation device arranged in an optical path of the image sensor. The method further includes coupling the mounting frame to an external rotating device that provides rotational movement.

In yet another embodiment, a panoramic imaging system includes a mounting frame removably coupled to an external RADAR system that provides rotational movement, an image sensor coupled to the mounting frame in a fixed position relative to the mounting frame, and an optical de-rotation device arranged in an optical path of the image sensor. The optical de-rotation device and the image sensor are oriented such that the optical de-rotation device and the image sensor are in the same plane. The optical de-rotation device removes motion-related blur that would be observed by the image sensor when the rotational movement causes the panoramic imaging system to rotate.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a perspective view of an illustrative panoramic imaging system according to one or more embodiments shown and described herein;

FIG. 2 schematically depicts a perspective view of another illustrative panoramic imaging system according to one or more embodiments shown and described herein;

FIG. 3 schematically depicts a perspective view of a panoramic imaging system mounted to an external rotating RADAR device according to one or more embodiments shown and described herein;

FIG. 4 schematically depicts a top-down cutaway view of a panoramic imaging system mounted to an external rotating device according to one or more embodiments shown and described herein;

FIG. 5 schematically depicts a side view of a panoramic imaging system mounted to an external rotating helicopter propeller according to one or more embodiments shown and described herein;

FIGS. 6A-6D schematically depict illustrative configurations of an image sensor, a lens, and one or more mirrors on a panoramic imaging system mounted to an external rotating device according to one or more embodiments shown and described herein;

FIG. 7 schematically depicts a block diagram of an illustrative interrelationship between various components of a panoramic imaging system according to one or more embodiments shown and described herein;

FIG. 8 schematically depicts a flow diagram of an illustrative method of manufacturing a panoramic imaging system according to one or more embodiments shown and described herein; and

FIG. 9 schematically depicts a flow diagram of an illustrative method of arranging a panoramic imaging system according to one or more embodiments shown and described herein.

### DETAILED DESCRIPTION

The embodiments described herein are generally directed to a panoramic imaging system that includes a single image sensor and an optical de-rotation device mounted to a frame. The panoramic imaging systems described herein do not have a rotating mechanism, thereby avoiding issues associated therewith, including additional moving parts, increased complexity of the device, increased manufacturing requirements, moving part damage, increased cost, lack of modular applications, and/or the like. Rather, the panoramic imaging systems leverage existing rotating devices to obtain rotational movement necessary for panoramic imaging. Existing rotating devices may include, for example, RADAR systems and helicopter propellers. When the panoramic imaging systems are mounted to the existing rotating device and the rotating device rotates, the image sensor may capture a panoramic image. The optical de-rotation device is arranged in the optical path of the image sensor and removes blur observed by the image sensor due to the rotational movement. As a result, the panoramic imaging systems described herein are less complex and therefore easier to manufacture, can be manufactured at a lower cost, are modular such that they can be adapted to any rotating device, and require less maintenance because they have fewer moving parts that are susceptible to damage. Moreover, the panoramic imaging systems described herein do not require additional tuning and monitoring of an internal rotating platform when placed upon an external rotating device. That is, the panoramic imaging systems described herein do not have an internal rotating platform that must be configured to rotate at a particular speed and direction to mitigate rotational movement caused by external devices.

As used herein, an “external rotating device” refers to a device that is wholly separate from the panoramic imaging system described herein. That is, the external rotating device is not a portion of the panoramic imaging system and is not incorporated within the panoramic imaging system. Rather, as described in greater detail herein, the panoramic imaging system is mounted to the external rotating device such that it can leverage the rotational movement of the external rotating device to capture a panoramic image.

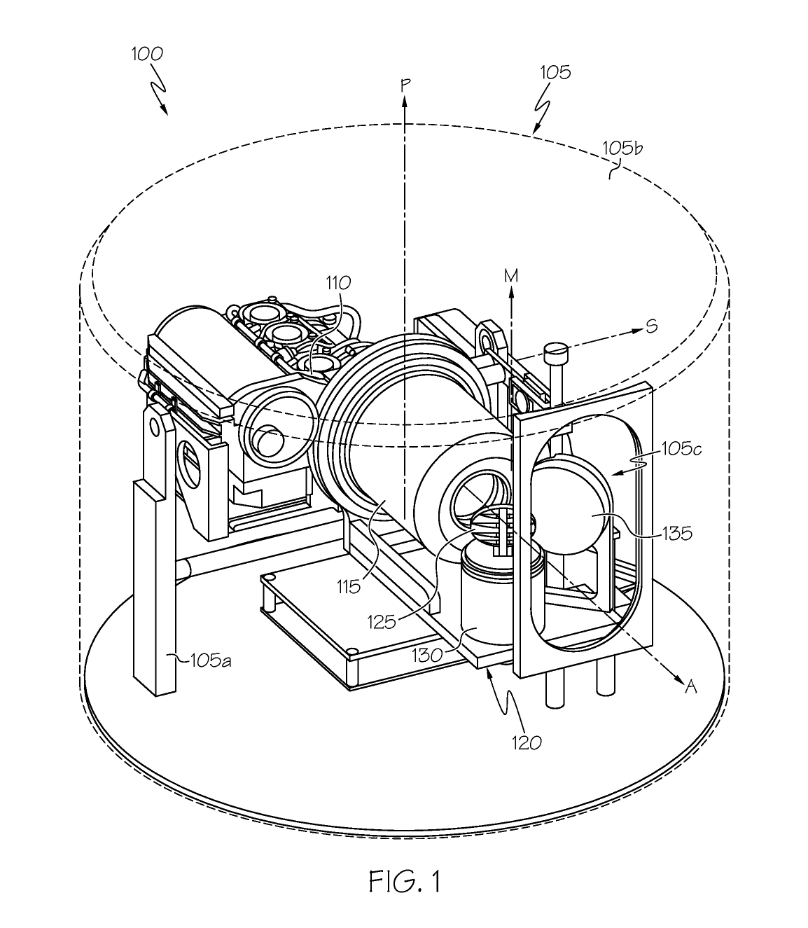

Referring now to the drawings, FIG. 1 depicts schematic view of a panoramic imaging system 100. The panoramic imaging system 100 generally includes a mounting frame 105, an image sensor 110, and an optical de-rotation device 120. In some embodiments, the panoramic imaging system 100 may further include a cover 105b, which may be a standalone element or a portion of the mounting frame 105. In such embodiments, the cover 105b may include a window 105c formed in a wall of the cover 105b so as to allow electromagnetic radiation to pass therethrough and enter the panoramic imaging system 100. In some embodiments, the window 105c may include a filter, polarizer, or the like so as to only allow electromagnetic radiation having particular characteristics, such as light at a particular wavelength, to pass through to the panoramic imaging system 100. It should generally be understood that the shape and size of the cover 105b and the shape, size, and location of the window 105c may be tailored to the specific application. For example, the shape, size, and configuration of the cover 105b and the window 105c may depend on the range of elevation imaged by the panoramic imaging system 100, the configuration and footprint of the components affixed to the mounting frame 105, and the configuration and footprint of an external rotating device to which the panoramic imaging system is mounted.

The mounting frame 105 generally provides structural support for the various other components of the panoramic imaging system 100 and may optionally include one or more components for mounting the panoramic imaging system 100 to an external rotating device, as described in greater detail herein. To provide structural support, the mounting frame 105 may include a platform and/or one or more structural support members 105a in addition to the cover 105b. The one or more structural support members 105a are not limited by this disclosure, and may generally be any members that maintain a positioning of the various components of the panoramic imaging system 100 with respect to each other, particularly when the panoramic imaging system 100 is mounted to the external rotating device when it is rotating. Thus, the various components of the panoramic imaging system 100, such as, for example, the image sensor 110, may be in a fixed position relative to the mounting frame 105.

The image sensor 110 is not limited by the present disclosure, and may generally be any image sensor 110 now known or later developed. The image sensor 110 may include one or more photodiodes (such as a photodiode array) that are generally configured to detect electromagnetic radiation. That is, the photodiode array may be configured to detect one or more of radio waves, microwaves, infrared radiation, visible light, ultraviolet radiation, x-rays, and gamma rays. Thus, the image sensor 110 may detect radiation in an ultraviolet wavelength band, a visible light wavelength band, a near-infrared wavelength band, a short-wave infrared wavelength band, a mid-wave infrared wavelength band, and/or a long-wave infrared wavelength band. Illustrative wavelengths of electromagnetic radiation detected by the image sensor 110 may include, but are not limited to, about 10 nanometers (nm) to about 400 nm, about 390 nm to about 700 nm, about 750 nm to about 3000 nm, about 900 nm to about 1700 nm, about 3000 nm to about 5000 nm, and about 5000 nm to about 14,000 nm. Specific wavelengths may include, but are not limited to, about 10 nm, about 100 nm, about 200 nm, about 300 nm, about 400 nm, about 500 nm, about 600 nm, about 700 nm, about 800 nm, about 900 nm, about 1000 nm, about 2000 nm, about 3000 nm, about 4000 nm, about 5000 nm, about 6000 nm, about 7000 nm, about 8000 nm, about 9000 nm, about 10,000 nm, about 11,000 nm, about 12,000 nm, about 13,000 nm, about 14,000 nm, or any value or range between any two of these values (including endpoints). In embodiments where the image sensor 110 detects electromagnetic radiation in a visible light wavelength band, the image sensor 110 may detect at wavelengths ranging from about 380 nm to about 450 nm, about 450 nm to about 495 nm, about 495 nm to about 570 nm, about 570 nm to about 590 nm, about 590 nm to about 620 nm, and/or about 620 nm to about 750 nm.

In addition, the image sensor 110 may detect electromagnetic radiation at any resolution and any refresh rate. Illustrative resolutions may include, but are not limited to, 15360 pixels×8640 pixels, 7680 pixels×4320 pixels, 4096 pixels×2160 pixels, 3840 pixels×2160 pixels, 2048 pixels×1080 pixels, 1998 pixels×1080 pixels, 1920 pixels×1080 pixels, 1440 pixels×1080 pixels, 1280 pixels×720 pixels, 720 pixels×576 pixels, 768 pixels×576 pixels, 720 pixels×480 pixels, 640 pixels×480 pixels, 320 pixels×240 pixels, and 160 pixels×120 pixels. Illustrative refresh rates may include, but are not limited to, about 20 Hertz (Hz), about 30 Hz, about 40 Hz, about 48 Hz, about 50 Hz, about 60 Hz, about 70 Hz, about 72 Hz, about 80 Hz, about 84 Hz, or any value or range between any two of these values (including endpoints).

Thus, for example, in one embodiment, the image sensor 110 is a camera configured to detect visible light at a resolution of 640 pixels×480 pixels and at a refresh rate of 60 Hz. In another embodiment, the image sensor 110 is a high definition camera configured to detect visible light at a resolution of 1280 pixels×1024 pixels and at a refresh rate of 60 Hz. However, it should be understood that the image sensor 110 may operate at other refresh rates and resolutions other than those stated above.

In some embodiments, the image sensor 110 may be an ultraviolet microchannel plate configured to detect radiation in the ultraviolet wavelength band.

In some embodiments, the image sensor 110 may be an infrared sensor configured to detect radiation in an infrared wavelength band. The infrared sensor may be configured to detect radiation in a near-infrared wavelength band, a shortwave-infrared wavelength, a midwave-infrared wavelength band, and/or a long-wave infrared wavelength band. The infrared sensor may include an infrared focal plane array, such as, for example, an infrared focal plane array housed within a vacuum flask (Dewar flask) for cooling the infrared focal plane array. In one embodiment, the infrared sensor may detect at a resolution of 1280 pixels×1024 pixels and at a refresh rate of 60 Hz. However, it should be understood that the infrared sensor may operate at a refresh rate other than 60 Hz and may detect at a resolution other than 1280 pixels×1024 pixels.

In some embodiments, the image sensor 110 may be coupled to a lens 115. The lens 115 may be any transmissive optical device that affects the focus of a beam of radiation, particularly a beam entering the image sensor 110. Accordingly, the lens 115 may be positioned within an optical path of the image sensor 110 such that any radiation passes through the lens 115 before reaching the image sensor 110. In some embodiments, the lens 115 may focus the radiation on one or more portions of the image sensor 110. In some embodiments, the lens 115 may be specific to the type of radiation that is sensed by the image sensor 110. For example, the lens 115 may be a microwave lens for affecting the focus of radiation having a wavelength in the microwave band. It should be understood that the lens 115 may include a body and incorporate any number of parabolic elements, prism elements, light redirection elements, and/or the like.

Still referring to FIG. 1, the optical de-rotation device 120 may generally be positioned in an optical path of the image sensor 110 and may further be oriented such that the optical de-rotation device 120 and the image sensor 110 are located in the same plane. In some embodiments, the image sensor 110 and the optical de-rotation device 120 may be in a plane such that an optical axis of the image sensor 110 is substantially perpendicular to the axis of rotation of the external rotating device.

The optical de-rotation device 120 presented herein is merely illustrative. As such, it is not limited by this disclosure and may generally be any optical de-rotation device now known or later developed. For example, certain optical de-rotation devices may include one or more mirrors and/or one or more drive devices, such as, for example, one or more motors. The one or more mirrors are not limited by this disclosure, and may generally be any reflective surface. Illustrative mirrors may include, but are not limited to, a fast steering mirror, a continuous rotation multi-faceted mirror, an acousto-optic beam steering assembly, and a prism. A fast steering mirror is generally a high resolution beam steering device that includes a movable and/or deformable mirror that reflects a beam of electromagnetic radiation. A continuous rotation multi-faceted mirror is generally a mirror having a plurality of rings of facets that continuously rotates. Each ring of facets is angled at a particular angle, and angled differently with respect to other rings. As such, each ring offers surveillance over a 360° field of view. An acousto-optic beam steering assembly generally refers to a beam steering device based on planar electro-optic thermal-plastic prisms and a collimator lens array.

In the embodiment depicted in FIG. 1, the optical de-rotation device 120 may include a scanning mirror 125 and a folding mirror 135. The scanning mirror 125 may be affixed to a drive shaft (not shown) of a scanning mirror motor 130. In addition, the scanning mirror 125 may be positioned in the optical path of the image sensor 110. The folding mirror 135 may be positioned in the optical path of the scanning mirror 125. While the embodiment depicted in FIG. 1 includes one folding mirror 135, other embodiments may include more than one folding mirror 135 or, alternatively, may not have a folding mirror.

The field of view of the lens 115 is typically related to the rotation rate of an external rotating device on which the panoramic imaging system 100 is placed. Thus, the field of view of the lens 115 may be adjusted according to a particular application (e.g., adjusted to correspond to a particular RADAR rotational speed or the like). The field of view of the lens 115 is typically the quotient of the rotation rate of the external rotating device and the refresh rate of the image sensor 110. For example, in an embodiment in which the external rotating device is determined to rotate at a rate of 900° per second and the image sensor 110 has a refresh rate of 60 Hz, the field of view of the lens 115 may be 900°/sec divided by 60 Hz, which equals 15°. In some embodiments, the field of view of the lens 115 may be greater than the quotient of the rotation rate of the external rotating device and the refresh rate of the image sensor 110 to allow for overlapping neighboring fields of view so that successive fields of view may be stitched together to form a panoramic image. For example, in an embodiment in which the external rotating device rotates at 900° per second and the imaging device has a refresh rate of 60 Hz, the field of view of the lens 115 may be 900°/sec divided by 60 Hz, plus 2° to account for a degree of overlap on either side of the field of view so that successive fields of view may be stitched together to form a panoramic image, which equals 17°. Once the field of view has been captured for a particular area of coverage, such as, for example, a full 360° view around the image sensor 110, and the captured images are stitched together, the resulting panoramic image may be considered to be fully stitched and free from motion-related blur.

The scanning mirror 125 may be positioned such that, when the scanning mirror 125 is in a neutral position, a face of the scanning mirror 125 is oriented at an angle of about 45° relative to an optical axis A of the image sensor 110. However, it should be understood that in other embodiments, the angle at which the face of the scanning mirror 125 is oriented relative to the optical axis A of the image sensor 110 may be different from 45°, such as an angle greater than 45° or an angle less than 45°.

External rotation of the panoramic imaging system 100 may cause the scanning mirror motor 130 to rotate the scanning mirror 125 about an axis of rotation M in a direction that is opposite to the external rotation for a duration that is sufficient to expose the image sensor 110 to a fixed field of view, thereby enabling the image sensor 110 to form a stable image of the field of view. The scanning mirror 125 may typically rotate at a rate about the same as the rate at which the external rotating device rotates, though the scanning mirror 125 may also rotate at different rate than the rate at which the external rotating device rotates. The rate of rotation of the scanning mirror 125 may be controlled based the type of external device on which the panoramic imaging system 100 is mounted, such as by monitoring the speed and direction of movement of the external rotating device and directing the scanning mirror motor 130 to rotate the scanning mirror 125 at a faster or at a slower rate to correspond to the speed and duration of the monitored movement. In the embodiment depicted in FIG. 1, in which the panoramic imaging system 100 is scanning at 0° elevation, the axis of rotation M of the scanning mirror 125 is substantially parallel to an axis of rotation P of the external rotating device. In some embodiments, the axis of rotation M of the scanning mirror 125 may be located radially outward of the center of the external rotating device, while in other embodiments, the axis of rotation M of the scanning mirror 125 and the axis of rotation P of the external rotating device may be the same.

As described above, the optical de-rotation device 120 may allow the image sensor 110 to maintain a gaze on one or more fixed objects within its field of view, despite movement caused by the external rotating device. Once the image sensor 110 has been exposed to the fixed field of view for a duration sufficient to enable the image sensor 110 to form a stable image of the field of view, the scanning mirror motor 130 may rotate the scanning mirror 125 in a direction such that the scanning mirror 125 snaps back to an initial position, thereby exposing the image sensor 110 to the next field of view. As described in greater detail herein, successive fields of view may be stitched together to obtain a panoramic image that is free from motion-related blur. That is, the panoramic image is fully stitched and free from motion-related blur.

The panoramic imaging system 100 may scan at an elevation angle other than 0° (the elevation angle at which the embodiment depicted in FIG. 1 is configured to scan). In order to change the elevation of the field of view to which the image sensor 110 is exposed, the optical de-rotation device 120 may pivot up and down about an axis of rotation S. In some embodiments, the axis of rotation S of the optical de-rotation device 120 may be substantially parallel to the optical axis A of the image sensor 110 and substantially perpendicular to the axis of rotation P of the external rotating device.

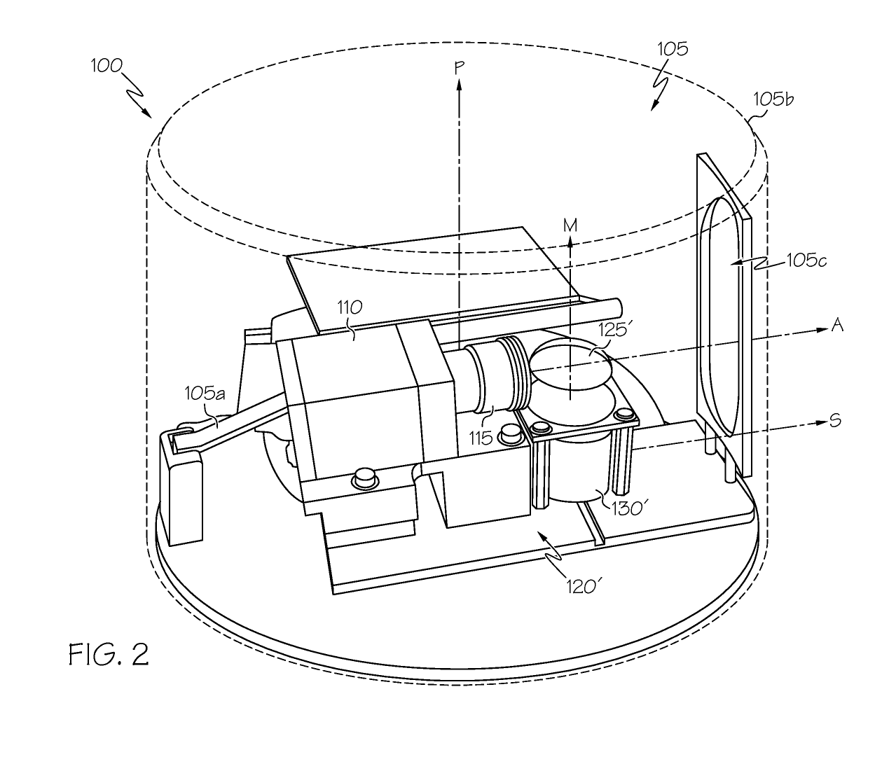

FIG. 2 depicts a panoramic imaging system 100 with an alternative optical de-rotation device 120′. The optical de-rotation device 120′ may include a scanning mirror motor 130′ and a scanning mirror 125′ affixed to a drive shaft (not shown) of the scanning mirror motor 130′. The scanning mirror 125′ may be positioned in the optical path of the image sensor 110. As shown in FIG. 2, the scanning mirror 130′ and the image sensor 110 are in the same plane.

The scanning mirror 125′ may be positioned such that, when the scanning mirror 125′ is in a neutral position, a face of the scanning mirror 125′ is oriented at an angle of about 45° relative to an optical axis A of the image sensor 110. However, it should be understood that in other embodiments, the angle at which the face of the scanning mirror 125′ is oriented relative to the optical axis A of the image sensor 110 may be different than 45°, including greater than 45° and less than 45°.

As an external rotating device (not shown) rotates in a first direction, the scanning mirror motor 130′ may rotate the scanning mirror 125′ in a second direction that is opposite to the first direction for a duration that is sufficient to expose the image sensor 110 to a fixed field of view, thereby enabling the image sensor 110 to form a stable image of the field of view. The scanning mirror 125′ may typically rotate at a rate about the same as the rate at which the external rotating device rotates. In addition, the scanning mirror 125′ may also rotate at a rate that is different from the rate at which the external rotating device rotates. Thus, the scanning mirror motor 130′ may be adjusted to rotate at a particular rate according to the particular application. In the embodiment depicted in FIG. 2, in which the panoramic imaging system 100 is scanning at 0° elevation, the axis of rotation M of the scanning mirror 125′ is substantially parallel to the axis of rotation P of the external rotating device on which the panoramic imaging system 100 is mounted. In some embodiments, the axis of rotation M of the scanning mirror 125′ is located radially outward of a center of the external rotating device, while in other embodiments, the axis of rotation M of the scanning mirror 125′ and the axis of rotation P of the external rotating device are the same.

Once the image sensor 110 has been exposed to the fixed field of view for a duration sufficient to enable the image sensor 110 to form a stable image of the field of view, the scanning mirror motor 130′ may rotate the scanning mirror 125′ in the first direction such that the scanning mirror 125′ snaps back to an initial position, thereby exposing the image sensor 110 to the next field of view.

The panoramic imaging system 100 may scan at an elevation angle other than 0° (the elevation angle at which the embodiment depicted in FIG. 2 is configured to scan). In order to change the elevation of the field of view to which the image sensor 110 is exposed, the optical de-rotation device 120′ may pivot up and down about an axis of rotation S. In some embodiments, the axis of rotation S of the optical de-rotation device 120′ may be substantially parallel to the optical axis A of the image sensor 110 and substantially perpendicular to the axis of rotation P of the external rotating device.

It should be understood that the various components of the panoramic imaging system 100, particularly the optical de-rotation devices 120, 120′ are merely illustrative. Thus, it is contemplated that panoramic imaging systems 100 that incorporate other configurations and/or other optical de-rotation devices can be used without departing from the scope of the present disclosure.

The panoramic imaging system 100 operates when placed on an external rotating device, which provides the rotational movement described above. The external rotating device may be any device that rotates, as such devices are not limited by the present disclosure. Because the external rotating device provides the rotation necessary to obtain a panoramic image, the panoramic imaging system 100 does not require its own internal rotating device, thereby reducing the complexity associated with systems that do require their own internal rotating devices.

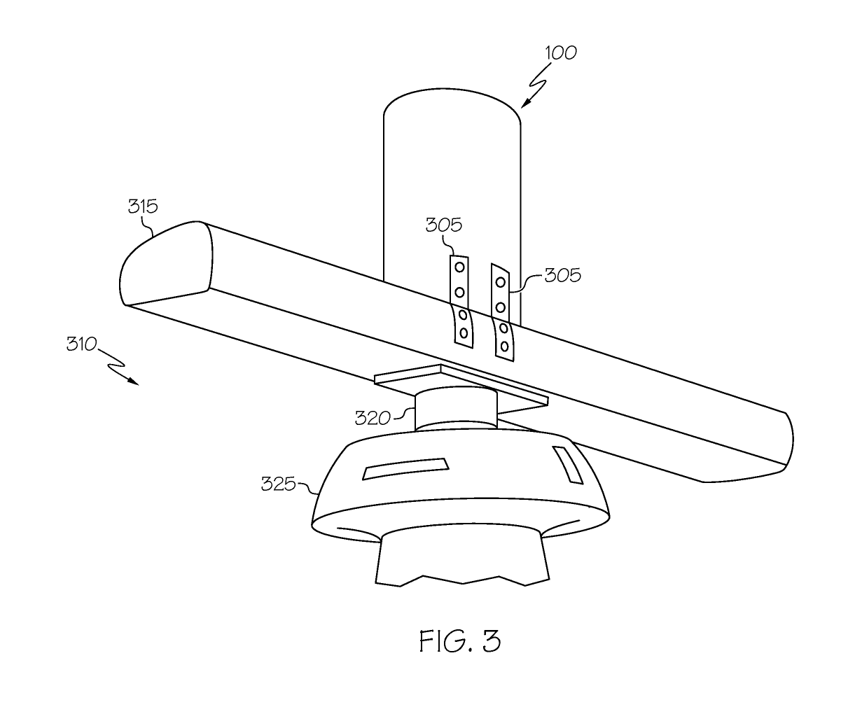

Referring to FIG. 3, the external rotating device may be one or more components of a RADAR system, particularly a rotating RADAR antenna 310. As shown in the embodiment depicted in FIG. 3, the panoramic imaging system 100 is mounted to an antenna radome 315 of the RADAR antenna 310. The antenna radome 315 may generally be a structural enclosure of one or more RADAR antennae contained therein. The antenna radome 315 may be coupled to a rotary joint 26, which may be coupled to a base 325. The rotary joint 320 may allow the antenna radome 315 (and also the panoramic imaging system 100 mounted thereto) to rotate about the base 325. The various components of the RADAR antenna 310 described herein are merely illustrative, and it should be understood that fewer, additional, or alternative components may be used to cause an external rotation effect on the panoramic imaging system 100 without departing from the scope of the present disclosure.

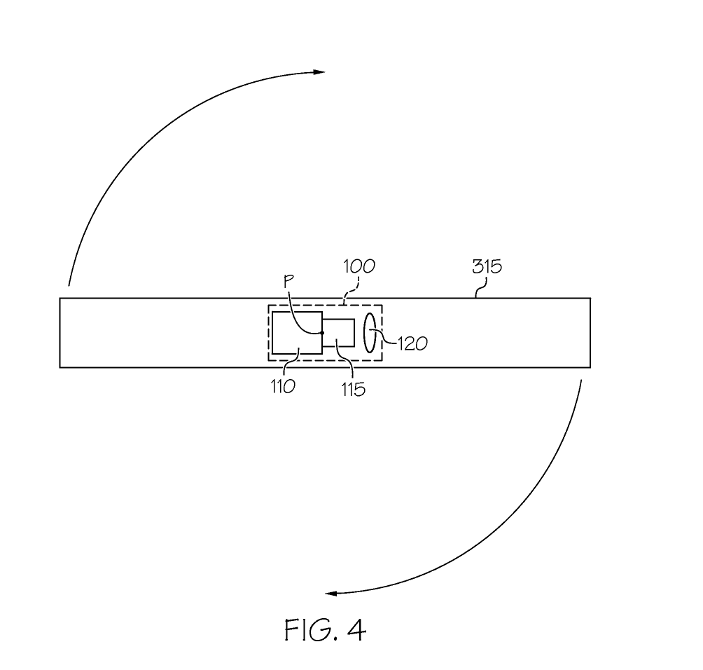

In various embodiments, the panoramic imaging system 100 may be mounted to a moving portion of the RADAR antenna 310, such as the antenna radome 315 depicted in FIG. 3. The panoramic imaging system 100 may generally be mounted on any portion of the antenna radome 315, such as, for example, a center portion. As shown in FIG. 4, centrally mounting the panoramic imaging system 100 on the antenna radome 315 places the axis of rotation P of the antenna radome 315 through a portion of the panoramic imaging system 100 (such as, for example, a central portion), as described in greater detail herein. Thus, when the antenna radome 315 rotates about its axis of rotation P (as indicated by the arrows), the panoramic imaging system 100 rotates in a similar manner along the same axis of rotation P.

Referring again to FIG. 3, the panoramic imaging system 100 may be secured to the external RADAR antenna 310 via one or more attachment devices 305. In some embodiments, the one or more attachment devices 305 may be a portion of the mounting frame 105 (FIGS. 1-2) that extends towards the external RADAR antenna 310 when the panoramic imaging system 100 is arranged in an assembled configuration. In other embodiments, the one or more attachment devices 305 may be independent components that are secured to the panoramic imaging system 100 (such as, for example, to the mounting frame 105 (FIGS. 1-2)) and at least one portion of the RADAR antenna 310 (such as, for example, to the antenna radome 315).

The one or more attachment devices 305 are not limited by this disclosure, and may include any means of attachment. Illustrative attachment devices 305 may include any combination of a clip, a bolt, a nut, a screw, a threaded rod, a rivet, a weld, a strap, an adhesive, a snap, a magnet, a clasp, a suction cup, and/or the like. Other types of attachment devices 305 and/or combinations thereof not specifically described in the above list may also be used without departing from the scope of the present disclosure. In addition, any number of attachment devices 305 may be used, particularly a number of attachment devices 305 that ensures the panoramic imaging system 100 is securely fastened to at least one portion of the RADAR antenna 310 without becoming disconnected when the antenna radome 315 rotates. In some embodiments, the one or more attachment devices 305 may provide a permanent or semi-permanent means of attaching the panoramic imaging system 100 to the RADAR antenna 310. In other embodiments, the one or more attachment devices 305 may provide a temporary means of attaching the panoramic imaging system 100 to the RADAR antenna 310 such that the panoramic imaging system 100 can be transported and placed on other external rotation devices and still function as described herein.

It should be understood that the panoramic imaging system 100 does not require the RADAR function of the external RADAR antenna 310 to operate. That is, the panoramic imaging system 100 merely leverages the movement of the external RADAR antenna 310 and does not leverage RADAR images to obtain a panoramic image.

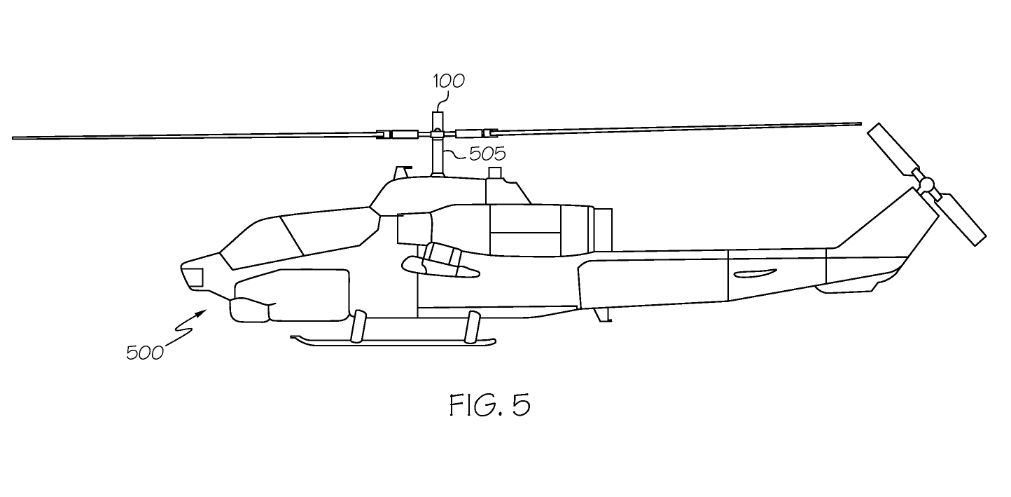

FIG. 5 depicts a helicopter 500 having a rotating propeller 505 that acts as the external rotating device for the panoramic imaging system 100. As described hereinabove with respect to FIG. 3, the panoramic imaging system 100 may be mounted on and attached to a portion of the propeller 505 such that an axis of rotation (not shown) of the propeller 505 passes through at least a portion of the panoramic imaging system 100. Rotational movement of the propeller 505 causes the panoramic imaging system 100 to rotate, as described in greater detail herein.

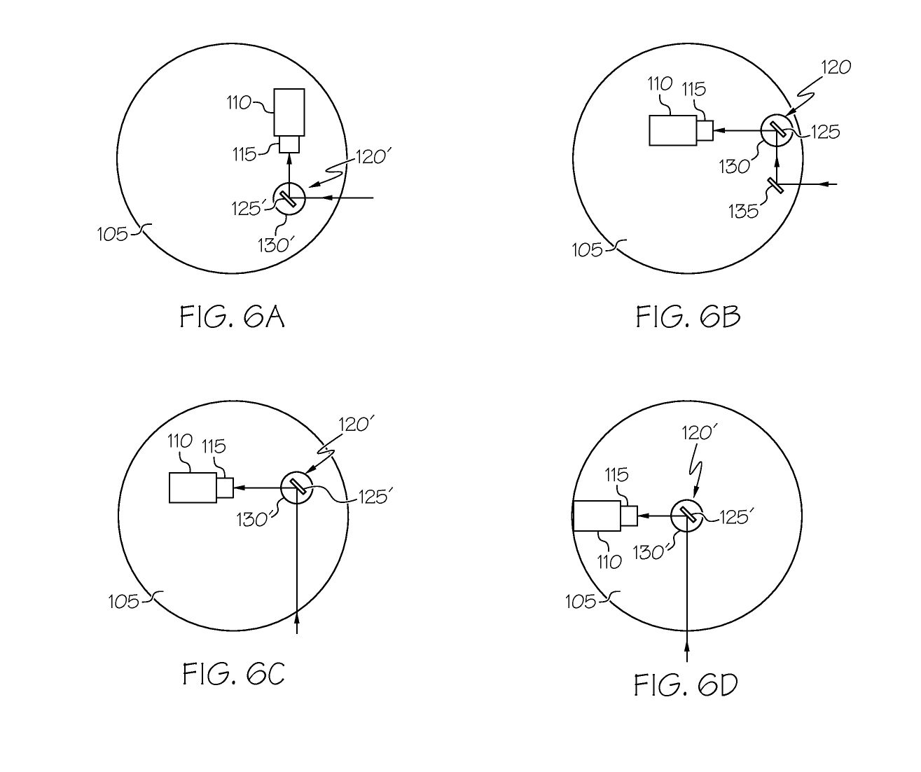

Referring now to FIGS. 6A-6D, several configurations of an image sensor 110, a lens 115, a scanning mirror motor 130, 130′, a scanning mirror 125, 125′, and an optional folding mirror 135 are schematically depicted when positioned within the panoramic imaging system 100 (FIGS. 1-2).

In the embodiment depicted in FIG. 6A, the image sensor 110 is positioned at or near an edge of a platform portion of the mounting frame 105 and is oriented such that an optical axis of the image sensor 110 extends along the edge. A scanning mirror 125′ mounted to a scanning mirror motor 130′ is positioned at or near an edge of the platform portion of the mounting frame 105 in the optical path of the image sensor 110. As the scanning mirror 125′ is oriented at about a 45° angle relative to the optical axis of the image sensor 110 in the embodiment depicted in FIG. 6A, light may reflect off the scanning mirror 125′, pass through the lens 115, and be detected by the image sensor 110. By positioning the scanning mirror 125′ at or near the edge of the platform of the mounting frame 105, motion parallax may be mitigated. The importance of mitigating motion parallax may depend on the relative speed of the objects being imaged. For example, in an aerial application, in which the relative speed of an object to be imaged may be high, it may not be important to mitigate motion parallax. In contrast, in a nautical application, in which the relative speed of an object to be imaged may be low, it may be more important to mitigate motion parallax.

In the embodiment depicted in FIG. 6B, the image sensor 110 is positioned at or near a center of rotation of the external rotating device and is oriented such that an optical axis of the image sensor 110 extends through the platform portion of the mounting frame 105. A scanning mirror 125 mounted to a scanning mirror motor 130 is positioned at or near an edge of the platform portion of the mounting frame 105 in the optical path of the image sensor 110. A folding mirror 135 is positioned at or near the same edge as the scanning mirror 125, such that the folding mirror 135 is in the optical path of the image sensor 110 and the scanning mirror 125. Light may reflect off the folding mirror 135, reflect off the scanning mirror 125, pass through the lens 115, and be detected by the image sensor 110. By positioning the scanning mirror 125 and the folding mirror 135 at or near the edge of the platform portion of the mounting frame 105, motion parallax may be mitigated.

In the embodiment depicted in FIG. 6C, the image sensor 110 is positioned at or near a center of the platform portion of the mounting frame 105 and is oriented such that an optical axis of the image sensor 110 extends through the platform. A scanning mirror 125′ mounted to a scanning mirror motor 130′ is positioned at or near an edge of the platform in the optical path of the image sensor 110. As the scanning mirror 125′ is oriented at about a 45° angle relative to the optical axis of the image sensor 110 in the embodiment depicted in FIG. 6C, light may reflect off the scanning mirror 125′, pass through the lens 115, and be detected by the image sensor 110. By positioning the scanning mirror 125′ at or near the edge of the platform, motion parallax may be mitigated.

In the embodiment depicted in FIG. 6D, the image sensor 110 is positioned at or near an edge of the platform portion of the mounting frame 105 and is oriented such that an optical axis of the image sensor 110 is directed towards a center of the platform. A scanning mirror 125′ mounted to a scanning mirror motor 130′ is positioned at a location on the platform that corresponds to a center of the external rotating device. In addition, the scanning mirror 125′ is positioned in the optical path of the image sensor 110. As the scanning mirror 125′ is oriented at about a 45° angle relative to the optical axis of the image sensor 110 in the embodiment depicted in FIG. 6D, light may reflect off the scanning mirror 125′, pass through the lens 115, and be detected by the image sensor 110.

The configurations depicted in FIGS. 6A-6D are merely illustrative and are not intended to limit the scope of this disclosure. Many other alternative configurations of the image sensor 110, the lens 115, the scanning mirror 125, 125′, and one or more folding mirrors 135 are possible without departing from the scope of the present disclosure.

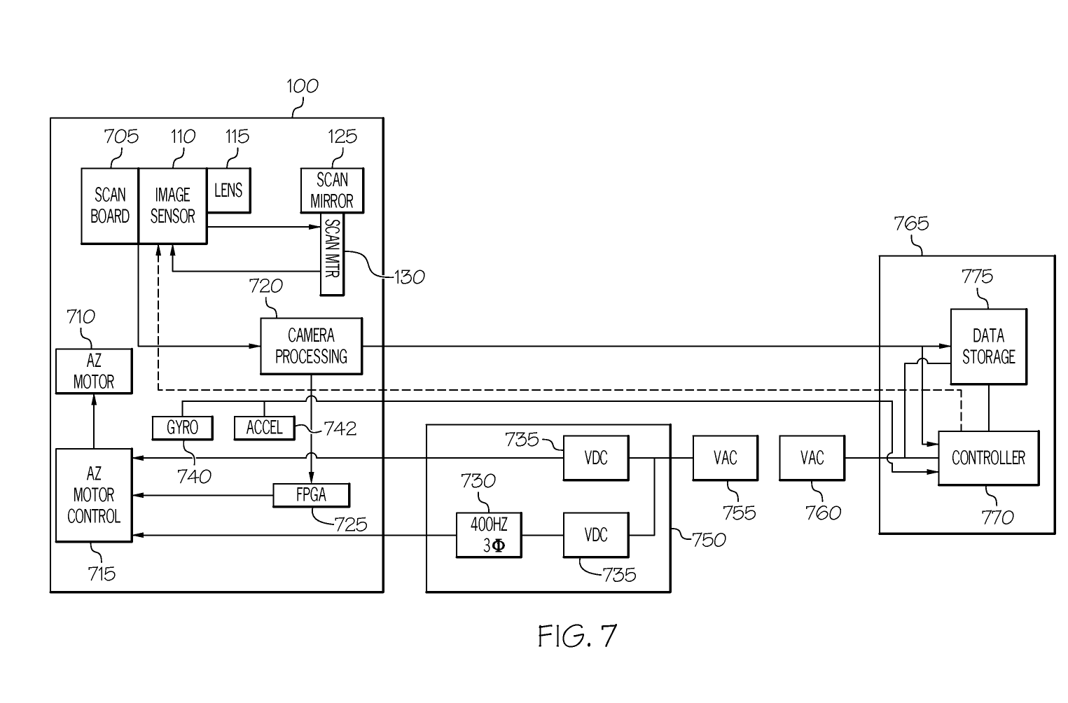

Referring now to FIG. 7, a block diagram illustrating the interrelationship of the various components of the panoramic imaging system 100 is schematically depicted. The panoramic imaging system 100 is connected to a power supply module 750 and a system interface module 765. The panoramic imaging system 100 may be connected to the power supply module 750 and/or the system interface module 765 by any type of wired or wireless communication now known or later developed. In addition to the components described herein with respect to FIGS. 1 and 2 (e.g., the image sensor 110, the lens 115, the scanning mirror 125, and the scanning mirror motor 130), the panoramic imaging system 100 may further include an azimuth motor 710, an azimuth motor controller 715, a camera processing module 720, and a field programmable gate array (FPGA) 725.

In some embodiments, the panoramic imaging system 100 may further include an accelerometer 742 and/or a gyroscope 740 to capture azimuth rotation observed by the panoramic imaging system 100. That is, the accelerometer 742 and/or the gyroscope 740 may be used to determine an orientation of the panoramic imaging system 100 and/or a component thereof such that the orientation can be adjusted so that azimuth rotation is captured when the rotational movement from the external rotating device causes the panoramic imaging system 100 to rotate.

In the embodiment illustrated in FIG. 7, the power supply module 750 may include at least one DC power supply module 735 and at least one AC power supply module 730. The DC power supply module 735 may convert power from an external power source 755 (e.g., a 110 VAC power source) to DC power (e.g., 28 VDC). The power output by the DC power supply module 735 may be supplied to components in the panoramic imaging system 100 such as, for example, a scanning board 705, the image sensor 110, the lens 115, the scanning mirror 125, the scanning mirror motor 130, the azimuth motor controller 715, the azimuth motor 710, the field programmable gate array 725, the gyroscope 740, and the accelerometer 742. The AC power supply module 730 may include an inverter that inverts 28 VDC power into a 400 Hz three-phase power output. The AC power supply module 730 may supply power to the azimuth motor controller 715 and the azimuth motor 710.

The system interface module 765, which may receive power from an external power source 760, may have a data storage module 775 and a controller module 770. The data storage module 775 may be configured as a non-transitory, computer-readable medium and, as such, may include random access memory (including SRAM, DRAM, and/or other types of random access memory), flash memory, registers, removable memory such as compact discs (CD) and digital versatile discs (DVD), and/or other types of storage components.

The controller module 770 may be configured as a general purpose computing device with the requisite hardware, software, and/or firmware, or as a special purpose computing device designed specifically for performing the functionality described herein. The controller module 770 may include a processor, input/output hardware, network interface hardware, a data storage component, and a non-transitory memory component. The memory component may be configured as volatile and/or nonvolatile computer-readable medium and, as such, may include random access memory (including SRAM, DRAM, and/or other types of random access memory), flash memory, registers, compact discs (CD), digital versatile discs (DVD), and/or other types of storage components. A local interface is also included in the controller module 770 and may be implemented as a bus or other interface to facilitate communication among the components of the controller module 770. The processor may include any processing component configured to receive and execute computer readable code instructions. The input/output hardware may include a graphics display device, keyboard, mouse, printer, camera, microphone, speaker, touch-screen, and/or other device for receiving, sending, and/or presenting data. The network interface hardware may include any wired or wireless networking hardware, such as a modem, LAN port, wireless fidelity (Wi-Fi) card, WiMax card, mobile communications hardware, and/or other hardware for communicating with other networks and/or devices.

In operation, the controller module 770 of the system interface module 765 may control the camera processing module 720, the field programmable gate array 725, the image sensor 110, and the scanning mirror motor 130. The controller module 770 may control the various components of the panoramic imaging system 100 based on inputs received from one or more components interfaced therewith, such as, for example, the gyroscope 740 and/or the accelerometer 742. The field programmable gate array 725 may interface with the azimuth motor controller 715, which in turn controls the azimuth motor 710. In one embodiment, a digital logic level pulse (generated outside the image sensor 110) may be used to trigger the image sensor 110 and the scanning mirror motor 130. In one embodiment, the leading edge of the trigger pulse may trigger the scanning mirror motor 130 and the trailing edge of the trigger pulse may trigger the image sensor 110. A delay may be introduced to the trigger pulses in order to center a target that would otherwise overlap two fields of view into a single field of view.

The data output by the image sensor 110 may be transmitted to the camera processing module 720. The camera processing module 720 may process the received image data and transmit it to the data storage module 775. The data output by the image sensor 110 may also be transmitted to the controller module 770. Each image transmitted by the image sensor 110 typically corresponds to a field of view of the camera. A panoramic image of the full 360° area scanned by the image sensor 110 can be constructed from the successive fields of view transmitted by the image sensor 110. The received images may be displayed on the controller module 770 (e.g., on a computer monitor or a heads-up displayed at a time) so that only one field of view is displayed at a time. Alternatively, the received images may be displayed on the controller module 770 in a panoramic view by stitching together successive fields of view.

FIG. 8 depicts a flow diagram of an illustrative method of manufacturing a panoramic imaging system. As shown in FIG. 8, a mounting frame may be provided in step 805. As described in greater detail herein, the mounting frame may provide a stable surface to mount the various components of the panoramic imaging system to an external rotating device, since the panoramic imaging system lacks its own rotating device. Thus, the mounting device may be configured to mount to the external rotating device.

In step 810, an image sensor may be coupled to the mounting frame. Coupling the image sensor to the mounting frame may be via any means of fixture, and is not limited by this disclosure. In step 815, the image sensor may be arranged such that it is appropriately positioned relative to the various other components of the panoramic imaging system and/or the external rotating device. For example, the image sensor may be arranged such that it is in the same plane as the optical de-rotation device. In some embodiments, the image sensor may be coupled in a fixed position relative to the mounting frame such that the image sensor does not move relative to the mounting frame when the mounting frame is placed on a rotating external rotation device. In some embodiments, the image sensor may be coupled to the mounting frame in such a location so that a focal point of the image sensor is positioned at a center of rotational movement caused by the external rotating device when the mounting frame is coupled to the external rotating device, as described in greater detail herein.

In step 820, the optical de-rotation mechanism may be placed on the mounting frame and may further be arranged in step 825. As with the imaging device, the optical de-rotation mechanism may be placed and affixed to the frame by any means of fixture and may be arranged such that it is appropriately positioned relative to the various other components of the panoramic imaging system and/or the external rotating device. For example, the optical de-rotation mechanism may be arranged such that it is in the same plane as the image sensor and so that it is in the optical path of the image sensor, as described in greater detail herein. In some embodiments, placing the optical de-rotation mechanism may include placing one or more of a fast steering mirror, a continuous rotation multi-faceted mirror, an acousto-optic beam steering assembly, and a prism.

In some embodiments, any additional components of the panoramic imaging system may be coupled thereto in step 830. For example, as shown in step 830, an accelerometer and/or a gyroscope may be coupled to the mounting frame. However, it should be recognized that other components, whether or not described herein, may also be coupled to the mounting frame and/or various other portions of the panoramic imaging system, such as an azimuth motor, an azimuth motor control, an FPGA, a camera processing module, and/or the like.

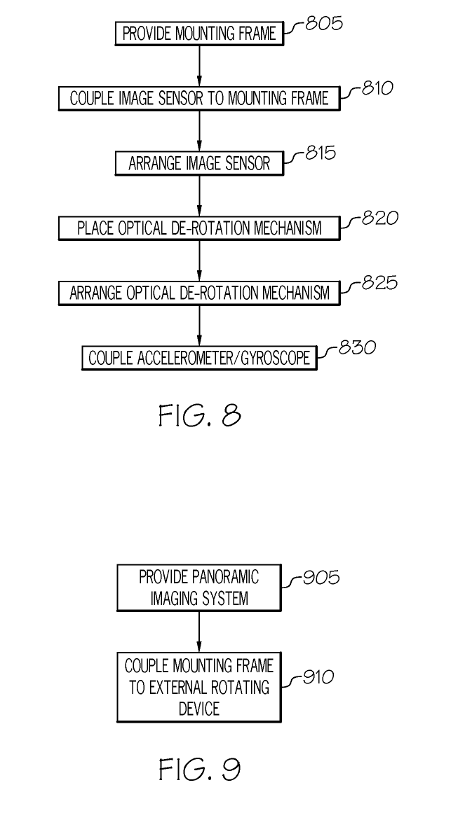

FIG. 9 depicts a flow diagram of an illustrative method of arranging a panoramic imaging system. As shown in step 9, the panoramic imaging system may be provided in step 905. In some embodiments, providing the panoramic imaging system may include providing a fully assembled and arranged panoramic imaging system, as described in greater detail herein. In other embodiments, providing the panoramic imaging system may include arranging the various components thereof, as described in greater detail herein. The panoramic imaging system may include at least a mounting frame, an image sensor coupled to the mounting frame, and an optical de-rotation device arranged in an optical path of the image sensor. The panoramic imaging system may be coupled to an external rotating device in step 910. Particularly, the mounting frame may be coupled to the external rotating device. As described herein, the mounting frame may be coupled with one or more attachment devices to secure the mounting frame to a portion of the external rotating device.

While the embodiments described herein utilize physical rotation of a scanning mirror in the optical path of an imaging device to stabilize an image as the imaging device rotates, embodiments are not limited thereto. For example, image blurring of a rotating imaging device can also be avoided by electro-optical deflection through non-linear material, acousto-optical deflection through non-linear material, and micro-mirror deflection.

It should now be understood that the panoramic imaging systems as described herein obviate the need for an integrated rotating mechanism to provide a panoramic image. Rather, the systems described herein can effectively leverage rotational movement from an external rotating device, such as a RADAR system or a helicopter propeller for example, to obtain rotational movement. Moreover, the systems are configured to reduce image blurring as the panoramic imaging system rotates by providing an optical de-rotation mechanism in the optical path of an image sensor portion of the panoramic imaging system.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A panoramic imaging system comprising:
a mounting frame;
an image sensor coupled to the mounting frame; and
an optical de-rotation device arranged in an optical path of the image sensor,
wherein:
the optical de-rotation device and the image sensor are oriented such that the optical de-rotation device and the image sensor are in the same plane, and
the optical de-rotation device removes motion-related blur that would be observed by the image sensor when a rotational movement external to the panoramic imaging system causes the panoramic imaging system to rotate.

2. The panoramic imaging system of claim 1, wherein the mounting frame is configured to be mounted to an external rotating device that provides the rotational movement.

3. The panoramic imaging system of claim 1, wherein the mounting frame is configured to be mounted to an external RADAR system that provides the rotational movement.

4. The panoramic imaging system of claim 1, wherein the mounting frame comprises one or more attachment devices for coupling the mounting frame to an external rotating device.

5. The panoramic imaging system of claim 1, wherein the image sensor is coupled to the mounting frame in a fixed position relative to the mounting frame.

6. The panoramic imaging system of claim 1, wherein the imaging system detects radiation in one or more of an ultraviolet wavelength band, a visible light wavelength band, a near infrared wavelength band, a short-wave infrared wavelength band, a mid-wave infrared wavelength band, and a long-wave infrared wavelength band.

7. The panoramic imaging system of claim 1, wherein the optical de-rotation device comprises one or more of a fast steering mirror, a continuous rotation multi-faceted mirror, an acousto-optic beam steering assembly, and a prism.

8. The panoramic imaging system of claim 1, wherein:
the rotational movement that is external to the panoramic imaging system is in a plane; and
the optical de-rotation device de-rotates in the plane such that the optical de-rotation device maintains a gaze of the image sensor on one or more fixed objects when the rotational movement external to the panoramic imaging system causes a rotational movement of the panoramic imaging system.

9. The panoramic imaging system of claim 1, further comprising one or more of an accelerometer and a gyroscope to capture azimuth rotation observed by the panoramic imaging system when the rotational movement external to the panoramic imaging system causes the panoramic imaging system to rotate.

10. The panoramic imaging system of claim 1, wherein:
the rotational movement external to the panoramic imaging system causes azimuth rotation of the image sensor; and
the image sensor collects a panoramic image that is fully stitched and free from motion-related blur.

11. The panoramic imaging system of claim 1, wherein a focal point of the image sensor is positioned at a center of the rotational movement external to the panoramic imaging system.

12. A method of arranging a panoramic imaging system, the method comprising:
providing the panoramic imaging system comprising:
a mounting frame,
an image sensor coupled to the mounting frame, and
an optical de-rotation device arranged in an optical path of the image sensor; and
coupling the mounting frame to an external rotating device that provides rotational movement.

13. The method of claim 12, wherein the external rotating device is an external RADAR system.

14. The method of claim 12, wherein coupling the mounting frame comprises attaching the mounting frame to the external rotating device with one or more attachment devices.

15. The method of claim 12, wherein the image sensor is coupled to the mounting frame in a fixed position relative to the mounting frame.

16. The method of claim 12, wherein the panoramic imaging system detects radiation in one or more of an ultraviolet wavelength band, a visible light wavelength band, a near infrared wavelength band, a short-wave infrared wavelength band, a mid-wave infrared wavelength band, and a long-wave infrared wavelength band.

17. The method of claim 12, wherein the image sensor is coupled to the mounting frame in a location such that a focal point of the image sensor is positioned at a center of rotational movement caused by the external rotating device.

18. The method of claim 12, wherein the optical de-rotation device comprises one or more of a fast steering mirror, a continuous rotation multi-faceted mirror, an acousto-optic beam steering assembly, and a prism.

19. The method of claim 12, wherein the panoramic imaging system further comprises one or more of an accelerometer and a gyroscope to the mounting frame.

20. A panoramic imaging system comprising:
a mounting frame removably coupled to an external RADAR system that provides rotational movement;
an image sensor coupled to the mounting frame in a fixed position relative to the mounting frame; and
an optical de-rotation device arranged in an optical path of the image sensor,
wherein:
the optical de-rotation device and the image sensor are oriented such that the optical de-rotation device and the image sensor are in the same plane, and
the optical de-rotation device removes motion-related blur that would be observed by the image sensor when the rotational movement causes the panoramic imaging system to rotate.
